(19) United States
(12) Patent Application Publication
(10) Pub. No.: US 2011/0241464 A1
(43) Pub. Date: Oct. 6, 2011

(54) Vibration Motor Surface Mounting Structure and Vibration Motor

(75) Inventors: Daichi Kadowaki, Meguro-ku (JP); Kazuaki Sato, Meguro-ku (JP)

(73) Assignee: Minebea Motor Manufacturing Corporation, Meguro-ku (JP)

(21) Appl. No.: 13/077,830

(22) Filed: Mar. 31, 2011

(30) Foreign Application Priority Data
Mar. 31, 2010 (JP) 2010-082281
Sep. 27, 2010 (JP) 2010-215276

(51) Int. Cl. H02K 7/075; F16M 13/02; F16B 47/00

(52) U.S. Cl. 310/81; 248/674

(57) ABSTRACT

In order to provide a vibration motor surface mounting structure capable of preventing a vibration motor from tipping over without using a part such as metal holder requiring complicated assembly, for a vibration motor having an eccentric weight mounted on the rotating shaft of the motor and mounted on a surface of a printed circuit board, a support member having extensions extending to the side of the rotating shaft on which the eccentric weight is mounted is used, a portion of this is fixed to the motor or the frame thereof, and a bottom surface including the extensions of the support member is secured to the mounting surface of the printed circuit board by soldering.

### BACKGROUND OF THE INVENTION

1. Field of the Invention

The present invention relates to a vibration motor surface mounting structure used for body sensory vibration in game equipments or portable communication equipments such as mobile phones or PHS, and a vibration motor equipped with this surfaces mounting structure.

In mobile communication equipments, in addition to a method of sounding a ring tone to alert a cell phone holder of an incoming call, there is also a method of alerting the cell phone holder of an incoming call by causing him to feel vibrations caused by rotation of an eccentric weight of a built-in vibration motor provided internally, and these modes can be switched as necessary. In addition, there are game systems in which enjoyment is enhanced by conveying to the user a vibration generated by a vibration motor inside the equipment in conjunction with the progress of a game.

This type of vibration motor is fixed inside the equipment and conveys generated vibrations to the equipment housing so that those vibrations can be experienced by the holder or user.

However, in these vibration motors, the position of the center of gravity comes toward the side of the eccentric weight because the eccentric weight is mounted on the rotating shaft thereof, and when the vibration motor is surface-mounted on a printed circuit board by reflow soldering, a mechanism is necessary to keep the device from overturning or positionally displacing.

2. Description of the Prior Art

In the invention disclosed in Unexamined Japanese Patent Application KOKAI Publication No. 2009-77521, as that countermeasure a structure is disclosed in which the motor body is inserted into a metal holder frame having a tapering protrusion to accomplish surface mounting. With this structure, the tapering protrusion supports the center of gravity that has come to the side of the eccentric weight, thereby making it possible to prevent tipping.

However, in the conventional structure disclosed in Unexamined Japanese Patent Application KOKAI Publication No. 2009-77521, it is necessary to prepare a metal holder separately from the vibration motor and in addition a process of assembling the metal holder on the motor body is necessary, creating the problem that production costs increase.

Recently, it is desired to make portable communication equipments smaller and accompanying this, it is desired to make vibration motors included therein smaller. The diameter of a vibration motor is for example nearly 4 mm, and use of components such as a metal holder in the conventional compact vibration motors causes the diameter of the motor to become larger. In addition, processes of manufacturing a metal holder suitable for such a compact motor are extremely complex, and process of assembling the metal holder on the motor is also extremely complex.

In addition, when using a metal holder, the thickness of this metal holder is added to the actual height, causing the problem that this is unsuitable for demands for greater thinness.

The present invention has been made in consideration of the foregoing and it is an object of the present invention to provide a vibration motor surface mounting structure that can prevent the vibration motor from tipping over, and a vibration motor equipped with this surface mounting structure, without using a component such as a metal holder, assembly of which is troublesome.

### SUMMARY OF THE INVENTION

In order to achieve the above object, the present invention is such that in a vibration motor surface mounting structure for mounting on a printed circuit board a vibration motor having an eccentric weight mounted on the rotating shaft of the motor, a part of a support member having extensions extending toward the side of the rotating shaft on which the eccentric weight is mounted is partly fixed to the vibration motor or a frame thereof and a bottom surface including the extensions of the support member is connected by soldering to a mounting surface of the printed circuit board.

In one aspect of the present invention, the support member is preferably a plate member and an upper surface of the plate member and a bottom surface of the frame of the motor are preferably connected by welding.

In another aspect of the present invention, it is preferable to connect a portion of the bottom surfaces of the frame of the motor other than the support member with the mounting surface of the printed circuit board by soldering.

In a further aspect of the present invention, it is preferable to provide a groove on a portion connecting to the mounting surface of the printed circuit board of the bottom surface of the support member.

In a still further aspect of the present invention, it is preferable to provide terminals for supplying electric current to the vibration motor on the bottom surface of the frame of the motor and to connect the terminals with the mounting surface of the printed circuit board by soldering.

In a still further aspect of the present invention, it is preferable to arrange the support member between the eccentric weight and the motor so as to support the motor and to connect the extensions of the support member with the mounting surface of the printed circuit board by soldering.

In a still further aspect of the present invention, it is preferred that the support member supports the motor on three surfaces, namely two side surfaces and the surface on the side on which the eccentric weight is mounted.

In a still further aspect of the present invention, it is preferable to fit the support member on the motor by adhesives or welding on three surfaces of the motor.

In a still further aspect of the present invention, it is preferred that the extensions of the support member has a larger width radially outwards of the motor rather than both side surfaces of the motor.

In the present invention, it is preferred that a vibration motor is mounted on a printed circuit board using the above-described surface mounting structure.

According to the present invention, it is possible to provide a vibration motor surface mounting structure that can prevent a vibration motor from tipping over without using members such as a metal holder, assembly of which is troublesome.

### BRIEF DESCRIPTION OF THE DRAWINGS

FIG. 1 is a perspective view of a vibration motor according to a first embodiment of the present invention as viewed from above;

FIG. 2 is a perspective view of the vibration motor of FIG. 1 as viewed from below;

FIG. 3 is a side view of the vibration motor of FIG. 1;

FIG. 4 is a bottom view of the vibration motor of FIG. 1;

FIG. 5A is a perspective view showing the support member 3 shown in FIG. 1 with the bottom surface of the motor shown in FIG. 1 oriented upside down, and FIG. 5B is a side view of the support member 3 as viewed from the right side in FIG. 5A,

FIG. 6 is a plan view of lands on a printed circuit board;

FIG. 7 is a side cross-sectional view of the support member 3 welded onto the motor 1 when the motor shown in FIG. 1 is a coreless motor;

FIG. 8 is a side cross-sectional view of the structure when the motor of the vibration motor surface mounting structure according to the present invention is a motor with a core;

FIG. 9 is a perspective view of a vibration motor according to another embodiment of the present invention;

FIG. 10 is a side view of the vibration motor of FIG. 9 as viewed from the right side;

FIG. 11 is a perspective view of the state with the eccentric weight removed from the vibration motor of FIG. 9;

FIG. 12 is a perspective view of the support member by itself that supports the motor;

FIG. 13 is also a perspective view of the support member of FIG. 12 as viewed from the back side in FIG. 4 and

FIG. 14 is a perspective view showing a still another example different from FIG. 12 of the support member supporting the motor.

### DETAILED DESCRIPTION OF THE PREFERRED EMBODIMENTS

The vibration motor surface mounting structure according to the preferred embodiments of the present invention will now be described in detail below with reference to the accompanying drawings.

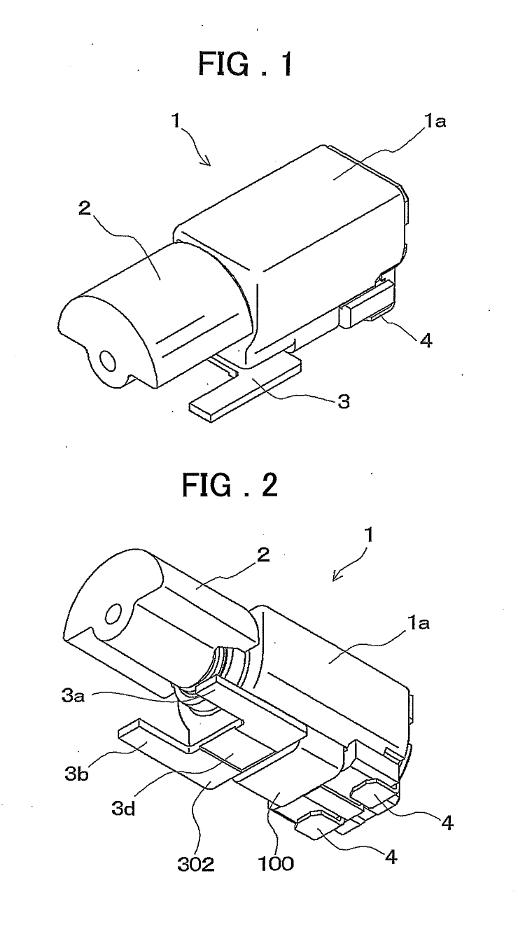

FIG. 1 is a perspective view of a vibration motor according to a first embodiment of the present invention, as viewed from above.

In addition, FIG. 2 is a perspective view of the vibration motor of FIG. 1 as viewed from below.

An eccentric weight 2 is mounted on a rotating shaft of a motor 1. When the rotating shaft of this motor 1 rotates, the eccentric weight 2 is also rotated, thereby generating vibrations. The motor 1 according to the present embodiment has a diameter of for example just less than 4 mm.

A support member 3 for supporting the motor 1 on a printed circuit board is provided on the bottom surface of the motor 1, and in addition, terminals 4 for supplying electric to drive the rotating shaft of the motor 1 to rotate are exposed.

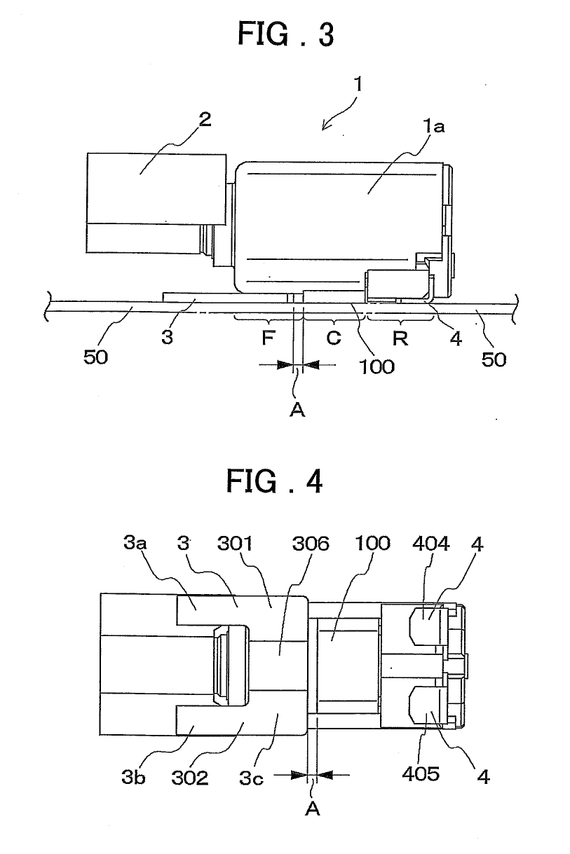

FIG. 3 is a side view of the vibration motor 1 shown in FIG. 1 and FIG. 4 is a bottom view of this vibration motor 1.

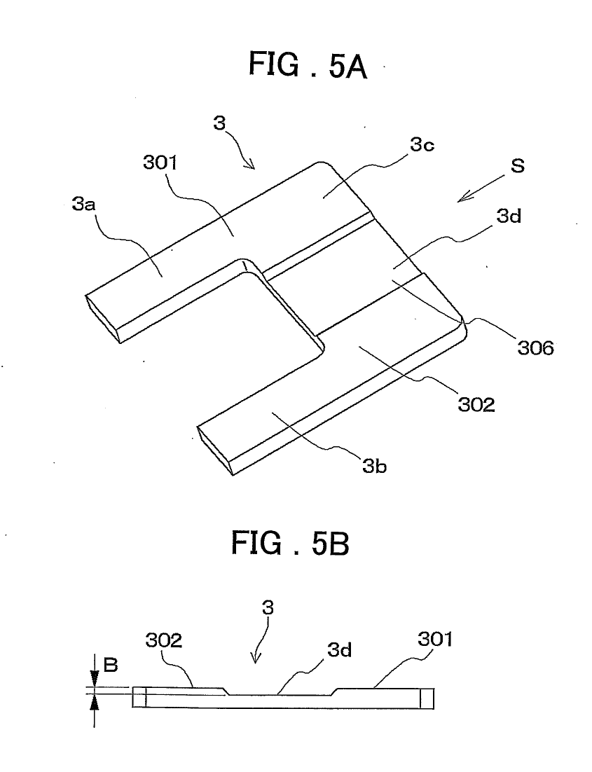

A frame 1a of the motor 1 is shaped such that the bottom surface thereof on the side of the printed circuit board has partly differences in level. For example, a portion F on the side of the eccentric weight 2 in an axial direction of the bottom surface of the frame 1a of the motor 1 is dented than a central portion C, as shown in FIG. 3, and a support member 3 is fixed to this dented portion F. While described in detail below, the support member 3 has a groove 3d on the bottom surface thereof that is the surface contacting the printed circuit board, as shown in FIG. 5A, and a surface 306 of the groove 3d is dented than remaining bottom surfaces 301 and 302 of the support member 3. In addition, as shown in FIGS. 2 through 4, two terminals 4 for supplying electric current to the windings of the motor are exposed on the bottom surface of the motor 1, and when the motor 1 to which the support member 3 is fixed is mounted on a printed circuit board, the bottom surfaces 301 and 302 of the support member 3 are mounted on the printed circuit board with bottom surfaces 404 and 405 of the two terminals 4 and a bottom surface 100 of the frame 1a of the motor 1 being coplanar with each other.

As shown in FIG. 3, a gap A is formed between the support member 3 and the bottom surface 100 of the frame 1a of the motor 1 in the axial direction of the motor 1. A groove with which the support member 3 mates may be provided on the bottom surface of the frame 1a of the motor 1 so as to define the position of the support member 3 to secure that this gap A is maintained.

FIG. 5A is a perspective view showing the support member 3 shown in FIG. 1 with the bottom surface of the motor 1 shown in FIG. 1 oriented upside down and FIG. 5B is side view of the support member 3 as viewed from the direction indicated by arrow S.

The support member 3 is manufactured through press processing of a steel sheet such as for example, hot rolled steel sheet SPCC or SPCD or SPCE that has undergone a solder-friendly plating treatment such as SnCu plating.

The support member 3 has a base 3c and has two extensions 3a and 3b extending therefrom toward the side on which the eccentric weight 2 is mounted as viewed from the motor shaft direction. A groove 3d is formed on the top surface shown in FIG. 5A (the bottom surface shown in FIG. 3) of the base 3c.

When fixing and mounting the vibration motor 1 onto a printed circuit board, first the bottom surface of the support member 3 shown in FIG. 5A is secured by welding onto the portion F (see FIG. 3) on the side of the eccentric weight 2 of the underside of the frame 1a of the motor 1.

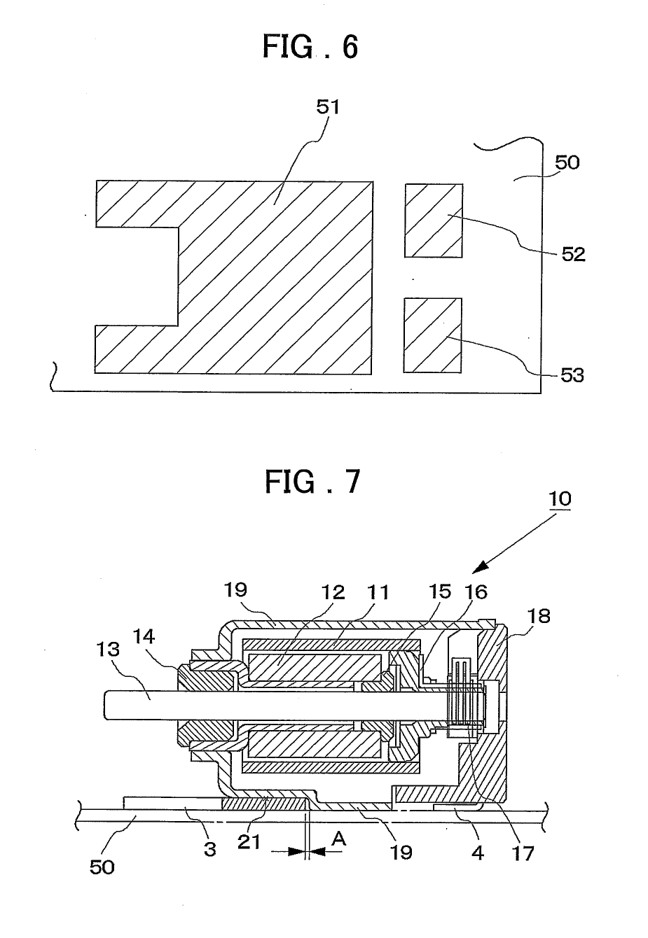

Following this, the vibration motor as a whole is mounted on the printed circuit board in such a manner that the bottom surfaces 301 and 302 of the extensions 3a and 3b of the support member 3 shown in FIG. 4, and the bottom surfaces 404 and 405 of the two terminals 4 along with the bottom surface 100 of the frame la of the motor 1 are brought into contact with the lands formed on the printed circuit board 50 (see FIG. 6), and is mounted on and secured to the printed circuit board by reflow soldering. At this time, the bottom surface 100 of the frame 1a of the motor 1 is also connected by soldering to the lands on the printed circuit board 50, so it is preferable to use for the frame 1a of the motor 1 a steel sheet such as for example, hot rolled steel sheet SPCC or SPCD or SPCE that has undergone a solder-friendly plating treatment (for example, SnCu plating).

FIG. 6 is a plan view of lands formed on a printed circuit board.

Lands 51, 52 and 53 are formed in advance on the printed circuit board 50. The lands 52 and 53 are lands for soldering the terminals 4 of the motor 1, and the land 51 is a land for securing with solder the bottom surface 100 of the frame 1a of the motor 1 and the bottom surfaces 301 and 302 of the support member 3.

As shown in FIGS. 5A and 5B, the groove 3d is formed in the support member 3, and moreover a gap (hereafter referred to as gap B) is created by the depth B of the groove 3d between the bottom surface 100 of the frame 1a of the motor 1 and the surface of the land 51, so the bonding strength between the support member 3 and the printed circuit board 50 is improved by solder which will penetrate the gap B.

In addition, as shown in FIG. 3, a gap A is provided between the support member 3 and the bottom surface 100 of the central portion C of the frame 1a of the motor 1, so the bonding strength between the support unit 3, the motor 1 and the printed circuit board 50 is improved by solder which will penetrate this gap A and form a fillet.

In addition, when mounting the motor 1 on the printed circuit board 50 by soldering, air heated in the reflow will penetrate the gap A and the gap B, making solder bonding easy and making it possible to reduce deviation in the surface direction of the motor 1 and the support member 3.

FIG. 7 is a side cross-sectional view of the surface mounting structure of the vibration motor when the vibration motor according to one variation of the first embodiment of the present invention is a coreless motor.

Electric current supplied to power supply terminals 4 of a vibration motor 10 is supplied to an armature 11 via a brush 17 and a commutator 16. Inside the armature 11, a magnet 12 is provided facing the armature 11, and this magnet 12 is secured to a frame 19 of the motor 10.

A rotating shaft 13 of the motor 10 is fixed to the armature 11 and is supported on the frame 19 via bearings 14 and 15. A bracket 18 made of for example plastic, is provided on one end of the frame 19 in the axial direction, and the power supply terminal 4 is exposed on the bottom surface of the frame 19, penetrating this bracket 18. The support member 3 is welded onto and secured to the bottom surface of the frame 19 and a welding surface 21. In the example of FIG. 7, the eccentric weight 2 is not shown but is fixed for example by press-fitting, adhesives or the like to the rotating shaft 13 on the side opposite the bracket 18 in the axial direction.

In the vibration motor surface mounting structure of the above embodiment, the bottom surface 100 which contacts the printed circuit board 50 through levels on the bottom surface of the frame 19 of the motor, and the surfaces 301 and 302 of the support member 3 and the surfaces 404 and 405 of the two power supply terminals 4, are fixed by solder onto the printed circuit board 50, and so comparing with to the case where only the support member 3 is fixed onto the printed circuit board 50 as an example, bonding strength can be enhanced and it is possible to prevent tipping over of the vibration motor due to an accidental drop.

In FIG. 7, a coreless motor as an example of the vibration motor 1 is illustrated, but the present invention is not limited to this.

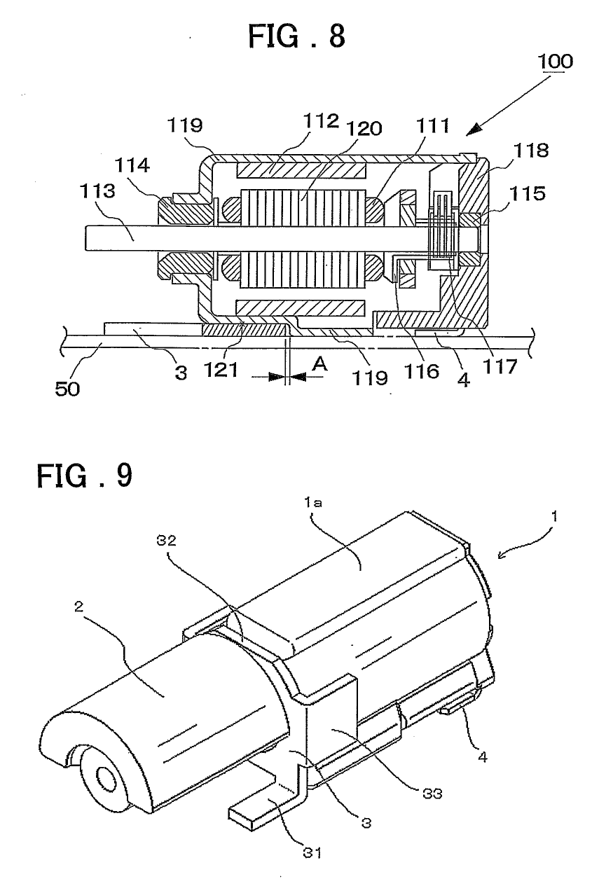

FIG. 8 is another modification of the present invention and a cross-sectional view of the vibration motor surface mounting structure according to another modification of the first embodiment of the present invention in which the motor is one with a core.

The electric current supplied to power supply terminals 4 of the vibration motor 100 is supplied to an armature 111 via a brush 117 and a commutator 116. The armature 111 has a core 120. Inside a frame 119 of the motor 100, a magnet 112 is provided facing the core 120, and the magnet 112 is fixed to the inner wall of the frame 119.

A rotating shaft 113 of the vibration motor 100 is fixed to the armature 111 and is supported on the frame 119 via bearings 114 and 115. A bracket 118 made of for example plastic is provided on one end of the frame 119 in the axial direction, and the power supply terminal 4 is exposed on the bottom surface of the frame 119, penetrating this bracket 118. The support member 3 is welded onto and secured to the bottom surface of the frame 119 and a welding surface 121. In the example in FIG. 8, the eccentric weight 2 is not shown but is fixed for example by press-fitting, adhesives or the like to the rotating shaft 113 on the side opposite the bracket 118 in the axial direction.

In the vibration motor surface mounting structure shown in FIG. 8, like the one shown in FIG. 7, the surface which contacts the printed circuit board 50 through levels on the bottom surface of the frame 119 of the vibration motor 100, and the bottom and front surfaces of the support member 3 and the bottom surfaces of the two terminals 4, are fixed by solder onto the printed circuit board 50, and so comparing with the case where only the support member 3 is fixed onto the printed circuit board 50, bonding strength can be enhanced and tipping of the vibration motor due to accidental dropping can be prevented.

As the manufacturing process of the vibration motor surface mounting structure shown is FIG. 8, it is necessary to secure the magnet 112 to the inner wall of the frame 119, but the following process may be taken. That is to say, prior to securing the magnet 112 to the frame 119, a support member 3 is welded and secured to the bottom surface of the frame 119, and after welding, the magnet 112 is secured by an adhesive to the inner wall of the frame 119. Then, a preassembled armature core bracket is press-fitted into the frame 119, and the process is finished by fixing the eccentric weight 2 to the rotating shaft 113.

In the above-described embodiment, an example in which a broad groove 3d is provided in the bottom surface (on the side contacting the printed circuit board 5) of the support member 3 has been shown, but this is intended to be illustrative but not limitative. For example, grooves of narrow width may be formed.

FIGS. 9 through 13 show a vibration motor surface mounting structure according to another embodiment of the present invention, which will be explained in detail below.

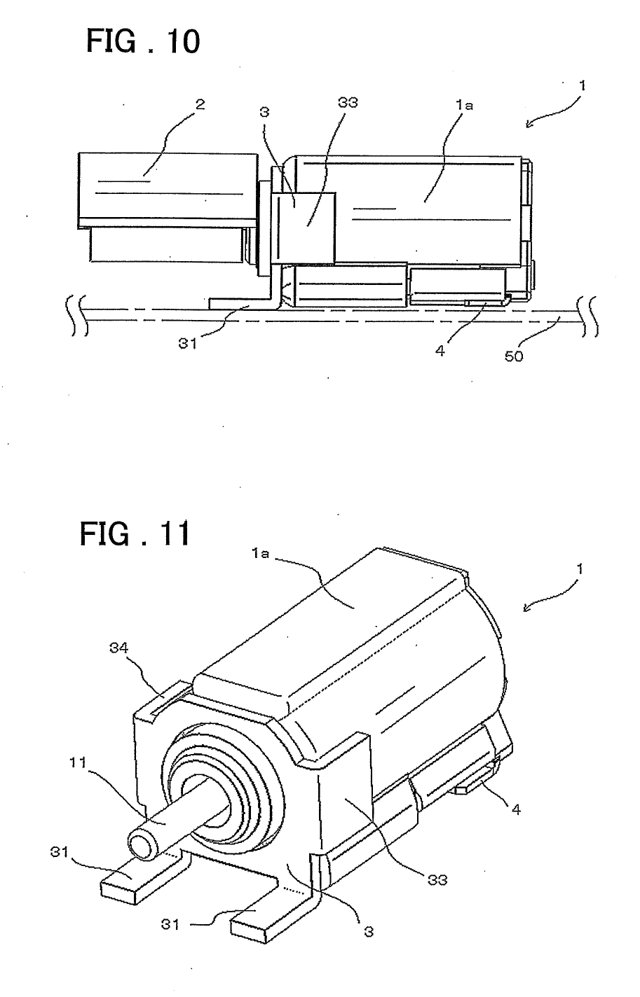

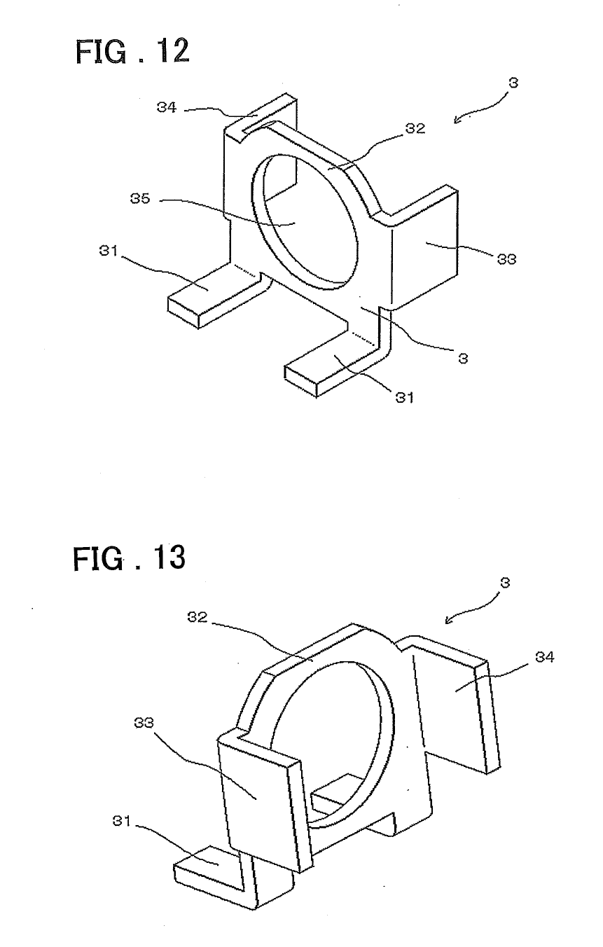

FIG. 9 is a perspective view of a vibration motor, FIG. 10 is a side view of the vibration motor of FIG. 9 as viewed from the right side, FIG. 11 is a perspective view of the vibration motor shown in FIG. 9 with an eccentric weight removed therefrom, and FIGS. 12 and 13 are perspective views of the support member for use in the motors shown in FIG. 9.

An eccentric weight 2 is mounted on a rotating shaft 11 of a vibration motor 1. When the rotating shaft 11 of the vibration motor 1 rotates, the eccentric weight 2 also rotates, and as a result vibrations of the vibration motor 1 are generated. The vibration motor 1 is a compact motor having a diameter is smaller than for example 5 mm.

A support member 3 for supporting the vibration motor 1 on a printed circuit board 50 is arranged between the eccentric weight 2 and the vibration motor 1 on the mounting side of the eccentric weight 2 on the vibration motor, as shown in FIG. 10, and in addition, the power supply terminals 4 for supplying electric current that causes the rotating shaft 11 to rotate are exposed on the side on which the eccentric weight 2 is not mounted in the axial direction of the vibration motor 1.

As can be understood from FIGS. 12 and 13, the support member 3 has two legs 31 connected to the printed circuit board 50. In addition, on the underside of the frame 1a of the vibration motor 1, that is to say on the side connecting to the printed circuit board 50, two power supply terminals 4 are exposed and the bottom surface of the two legs 31 of the support unit 3 and the bottom surface of the two power supply terminals 4 are coplanar with each others.

The support member 3 has a front surface 32 along with a left wing 34 and a right wing 33 extending at a right angle to the left and right, respectively, and an opening 35 through which the rotating shaft 11 of the vibration motor 11 passes is provided in the front surface 32 substantially in the center. The opening 35 provided in the front surface 32 is smaller than the diameter of the eccentric weight 2, and so the support member 3 is mounted on the frame 1a of the vibration motor 1 prior to securing the eccentric weight 2 to the vibration motor 1.

FIG. 12 is a perspective view showing the support member unit 3 alone, and FIG. 13 is a perspective view of the support member 3 as viewed from the back side in FIG. 12.

The support member 3 can be manufactured by press processing of a steel sheet such as for example, hot rolled steel sheet SPCC or SPCD or SPCE which has undergone a solder-friendly plating treatment such as for example, SnCu plating.

The support member 3 has the left and right sides of the front surface 32 bent along the frame of the motor to form a right wing 33 and a left wing 34, with the width between the right wing 33 and the left wing 34, that is to say the width of the front surface 32, being substantially equal to or a little bit larger than the outer diameter of the frame 1a of the vibration motor 1, so that the motor frame 1a is surrounded on three sides by the front surface 32, the right wing 33 and the left wing 34. In addition, the bottom of the front surface 32 of the support member 3 is bent toward the side of the eccentric weight 2 in the axial direction of the motor to form two separate extended legs 31, 31. The front surface 32, the right wing 33 and the left wing 34 of the support member 3 are secured to the frame 1a by welding or an adhesive on its surfaces that contact the motor frame 1a.

After securing the front surface 32, the right wing 33 and the left wing 34 of the support member 3 to the motor frame 1a, the eccentric weight 2 is mounted to the rotating shaft 11 by for example press fitting or adhesives.

Following this step, the bottom surface of the extended legs 31, 31 of the support member 3 and the bottom surface of the two power supply terminals 4 of the vibration motor 1 are mounted on the printed circuit board 50 so as to contact lands (not shown) formed on the printed circuit board 50 (see FIG. 10), and are then fixed on the printed circuit board by reflow soldering.

In the vibration motor surface mounting structure according to this embodiment, the two extended legs 31, 31 of the support member 3 are bent toward the side opposite the vibration motor 1 (that is the side of the eccentric weight 2) so that it is possible to prevent the motor as a whole from tipping toward the side of the eccentric weight 2 because of the weight of the eccentric weight 2 at the time of reflow soldering. In addition, it is possible to minimize such concerns that the vibration motor 1 will detach from the printed circuit board due to vibration caused by rotation of the eccentric weight 2. In addition, strength against tipping of the vibration motor 1 in the axial direction is increased.

In addition, a thickness of the extended legs 31, 31 of the support member 3 is the same as or less than the thickness of the supply terminals 4 of the vibration motor 1, so that a height of the vibration motor does not increase by the support member 3 when applied and mounting height is not increased. This meets the requirement for demand of reduction in height of the vibration motor making it possible to respond to the need for thinness.

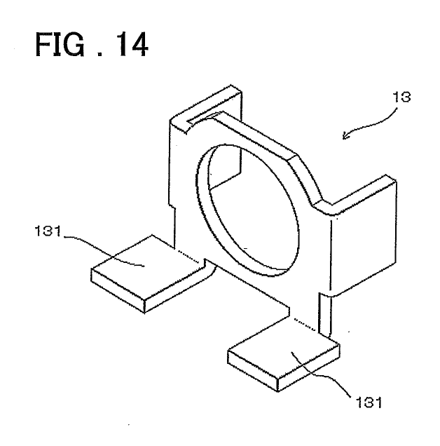

FIG. 14 is a perspective view of a modified support member 3 for use in the present invention.

The support member 3 shown in FIG. 14 differs only in the structure of extended legs from the support member 3 shown in FIGS. 12 and 13, with other structure thereof being the same as the above mentioned support member 3. Therefore, only the different points will be explained.

Each extended leg 131 of the support member 13 shown in FIG. 14 has a larger width than the diameter of the frame 1a of the vibration motor 1. In other words a distance between the outermost edges of the two extended legs 131, 131 is larger than a distance between the two side surfaces of the motor frame 1a. Thus, it is possible to minimize concerns that the vibration motor 1 may detach from the printed circuit board because of vibrations caused by rotation of the eccentric weight 2. In addition, strength against tipping of the vibration motor 1 in the direction of rotation is increased.

As explained above, according to the present invention, strength against tipping of the vibration motor can be increased without use of a metal holder for fixing a body of the vibration motor, but a height of the motor unit is not changed.

The preferred embodiments of the present invention were described above, but these are intended to be illustrative and not limitative and a variety of modification and combinations are possible within the scope of the subject matter disclosed herein.

What is claimed is:

1. A vibration motor surface mounting structure for mounting on a printed circuit board a vibration motor having an eccentric weight mounted on the rotating shaft of the motor, wherein:
a support member having extensions extending toward the side of the rotating shaft on which the eccentric weight is mounted is partly fixed to the vibration motor or a frame thereof; and
a bottom surface including the extensions of the support member is secured to a mounting surface of the printed circuit board by soldering.

2. The vibration motor surface mounting structure according to claim 1, wherein the support member is a plate member and an upper surface of the plate member and a bottom surface of the frame of the motor are connected by welding.

3. The vibration motor surface mounting structure according to claim 2, wherein a part of the bottom surfaces of the frame of the motor other than the support member with the mounting surface of the printed circuit board by soldering.

4. The vibration motor surface mounting structure according to claim 2, wherein a groove is provided on a portion of the bottom surface of the support member, which is connected to the mounting surface of the printed circuit board.

5. The vibration motor surface mounting structure according to claim 2, wherein terminals for supplying electric current to the vibration motor are provided on the bottom surface of the frame of the motor, and the terminals are secured to the mounting surface of the printed circuit board by soldering.

6. A vibration motor mounted on a printed circuit board using the surface mounting structure according to claim 1.

7. The vibration motor surface mounting structure according to claim 1, wherein the support member is arranged between the eccentric weight and the motor so as to support the motor, and the extensions of the support member are secured to the mounting surface of the printed circuit board by soldering.

8. The vibration motor surface mounting structure according to claim 7, wherein the support member supports the vibration motor on three surfaces, namely the two side surfaces and the surface on the side on which the eccentric weight is mounted.

9. The vibration motor surface mounting structure according to claim 8, wherein the support member is fixed to the vibration motor by adhesives or welding on the three surfaces of the motor.

10. The vibration motor surface mounting structure according to claim 7, wherein the extensions of the support member has a larger width radially outwards of the motor than both side surfaces of the motor.

11. A vibration motor fixedly mounted on a printed circuit board using the surface mounting structure according to claim 7.
